(19) United States
(12) Patent Application Publication
(10) Pub. No.: US 2010/0275219 A1
(43) Pub. Date: Oct. 28, 2010

(54) SCSI PERSISTENT RESERVE MANAGEMENT

(75) Inventors: William G. Carlson, Poughkeepsie, NY (US); Ian MacQuarrie, San Jose, CA (US); Eric Wieder, New Paltz, NY (US); Bin Ye, Poughkeepsie, NY (US)

Correspondence Address: CANTOR COLBURN LLP-IBM POUGHKEEPSIE, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/428,831

(22) Filed: Apr. 23, 2009

(51) Int. Cl. G06F 9/44; G06F 15/173

(52) U.S. Cl. 719/326; 709/224

(57) ABSTRACT

A network storage monitor system includes a device driver running on each of at least one first computer and a monitor application running on a second computer in communication with the each first computer. Each first computer also is in communication with a network storage switch and the network storage switch is in communication with at least one storage device. Each device driver sends to the second computer data regarding a storage event when the storage event is initiated by the respective first computer.

### BACKGROUND

The present invention relates to resource allocation, and more specifically, to controlling and monitoring the allocation of resources in a storage area network (SAN).

A storage area network (SAN) is a computer based architecture to attach remote computer storage devices (such as disk arrays, tape libraries, and optical jukeboxes) to servers in such a way that the devices appear as locally attached to the operating system. Although the cost and complexity of SANs are dropping, they are still uncommon outside larger enterprises.

In some cases, Small Computer System Interface (SCSI) is used to connect the server (computer) to a peripheral device in a SAN network. SCSI is a set of standards for physically connecting and transferring data between computers and peripheral devices. The SCSI standards define commands, protocols, and electrical and optical interfaces. SCSI is most commonly used for hard disks and tape drives, but it can connect a wide range of other devices, including scanners and CD drives. The SCSI standard defines command sets for specific peripheral device types; the presence of “unknown” as one of these types means that in theory it can be used as an interface to almost any device, but the standard is highly pragmatic and addressed toward commercial requirements.

Large, complex SAN environments are vulnerable to operator errors, software (middleware), and hardware problems causing incorrect persistent SCSI reserve placement or release of storage resources. For example, storage devices (or peripherals) may have reserves removed incorrectly leaving them exposed to multiple hosts writing to the device. This may lead to data loss or corruption that occurs without an audit trail describing which reserves were released or placed and when. In addition, a server or other host may incorrectly reserve a device because of defective utilities or improper SAN zoning. Tracking the root cause of such errors may be impossible because the history of reserves placed (or released) had not been logged.

In short, in current systems there is no accounting or notification as part of the reserve placement or release process (or capability to initiate logging) at the protocol level. Hence, regardless of how an improperly placed or removed reserve is accomplished, the only failure signature is loss of access to storage or a device driver that reports a reservation conflict.

Current solutions to resolve the reserve placement are passive and require an operator to query the reserve status on a device using a proprietary utility that interfaces with the storage device controller. Based on the query status of the reserves and the knowledge of what device and endpoint need access, the operator can manually release/replace improperly placed reserves (this process is obviously subject to human error). This is clearly a reactive and not a proactive approach.

### SUMMARY

According to one embodiment of the present invention, in a network storage system comprising at least one application server including a device driver and an agent, at least one switch attached to the at least one application server, at least one storage device attached to the at least one switch and responsive to the device driver of the at least one application server, and a utility server, a network storage monitoring method is provided. The method of this embodiment includes storing data in the device driver related to a storage event created by the device driver in a new data object comprising records of at least a type of event, an identifier of a storage device to which the event relates, and a time at which the event occurred; sending data via the agent related to the storage event from the at least one application server to the utility server; receiving the data related to the storage event at the utility server; and storing the data related to the storage event on the utility server in a database.

Another embodiment of the present invention is directed to a computer program product comprising a computer readable storage medium containing instructions that, when read by a computer processor, execute a method that includes storing data in a device driver related to a storage event created by the device driver in a new data object comprising records of at least a type of event, an identifier of a storage device to which the event relates, and a time at which the event occurred; sending data via an agent installed on the device driver related to a storage event from at least one application server to a utility server; receiving the data related to the storage event at the utility server; and storing the data related to the storage event on the utility server in a database.

Another embodiment of the present invention is directed to a network storage monitor system that includes a device driver running on each of at least one first computer and a monitor application running on a second computer in communication with the each first computer, each first computer also being in communication with a network storage switch, and the network storage switch being in communication with at least one storage device, each device driver sending to the second computer data regarding a storage event when the storage event is initiated by the respective first computer.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 shows an example of a SCSI SAN fabric according to one embodiment of the present invention.

### DETAILED DESCRIPTION

Embodiments of the present invention provide for an augmented SCSI SAN device architecture to enable storage device hosts to log persistent reserve activity of every device it can access on the SAN fabric. In one embodiment, changes in the persistent reserve state of a device, enabled by changes according to the present invention, allow this reserve state change information from multiple application servers to be updated in a SAN-wide SCSI Reservation database and could trigger alerts to administrative entities that could then drive maintenance or diagnostics. To capture the initial state of the reserves on a SAN fabric, existing SCSI methods may be used to poll the existing reservations on the fabric (and update the SCSI Reservation database), and poll periodically thereafter.

In more detail, one embodiment of the invention includes modifying the SCSI device driver on a host device as described above and providing an additional element (structure) that stores the key information every time a SCSI reservation change is performed (reserve, release, break). Also the device driver can selectively enable (e.g. via a SCSI device command) SCSI debug information to log this structure (i.e. reserve state change information) as reserves are placed or removed on a SCSI device it can access. In combination with this, a software agent resident in operating systems connected to the SAN may be configured to allow both polling of existing reserves (through typical SCSI methods) and monitoring of the SCSI device driver logging described above. The agent relays this reserve information to a management (utility) server which stores it in a reservation database. Further, enhancement to the utility server and agent may allow selective management of reserves and notifications on state changes that could drive proactive action.

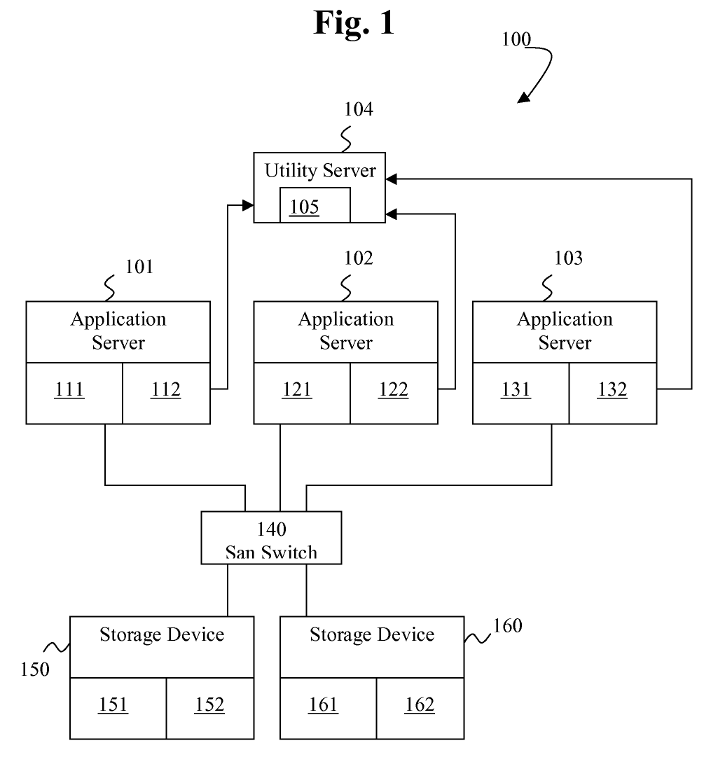

FIG. 1 shows an example of a system 100 according to an embodiment of the present invention. Of course, the system 100 could have any number elements and is not limited to that shown in FIG. 1.

The system 100 shown in FIG. 1 includes application servers 101, 102 and 103. Each application server shown in FIG. 1 may be a computing device that may require access to a storage or other peripheral device. The application servers 101, 102 and 103 all have a SCSI device driver. The application servers 101, 102 and 103 all have an agent that can access the local SCSI drivers and receive reserve information from it. In more detail, the first application server 101 includes a first SCSI driver 111 and a first agent 112, the second application server 102 includes a second SCSI driver 121 and a second agent 122 and the third application server 103 includes a third SCSI driver 131 and a third agent 132. In one embodiment, each driver and agent on one application server is the same as on another server. Of course, some or all of the application servers may have a slightly different driver than other application servers in the system 100.

The system 100 may also include a SAN switch 140. The SAN switch 140 is coupled to one or more storage devices 150 and 160. The SAN switch 140 controls access to by the application servers to the storage devices. In one embodiment, the SAN switch 140 may be any type of existing or later developed switch capable of connecting the application severs to the storage devices.

As shown, the SAN switch 140 is coupled to a first storage device 150 and the second storage device 160. Of course, the SAN switch 140 could be coupled to more or less storage devices than shown in FIG. 1. Each storage device in the system 100 may include one or more logical units. For example, the first storage device 150 may include logical units 151 and 152 and the second storage device 160 may include logical units 161 and 162. Or course, the exact configuration of the storage devices may vary and are shown by way of example only in FIG. 1. Collectively, the application servers 101, 102 and 103 (which may be part of a computing device), the SAN switch 140 and the storage devices 150 and 160 may be referred to as a SAN fabric.

The system 100 may also include a utility server 104. The utility sever 104 is a computing device that may include memory and is configured to poll or otherwise receive storage device reserve information from the agent on each application server. In particular, the utility server 104 may be configured to poll and receive updates from the agents 112, 122 and 132. The results of the poll/update may be stored in a SCSI Reservation Database 105.

The SCSI drivers 111, 121 and 131 on each application server 101, 102 and 103 may store the SCSI reserve log elements generated by the associated SCSI driver. In one embodiment, each time a SCSI reserve is made by the associated SCSI driver, that driver may create a store a structure that includes a record of the command made, a key, and a time the command was made. The command made could include, in one embodiment, place reserve, release reserve and break reserve. The key could be, in one embodiment, an identification of the particular device (LUN) to which the command applies. The time could be, for example, local time. The SCSI driver may be enabled to log this structure via a SCSI device (i.e., AIX chdev) command. This structure may also be requested from the SCSI driver through typical methods. The agents 112,122, and 132 are enabled to obtain this SCSI device driver structure through both monitoring the SCSI device driver log and also via periodic querying of the structure through typical methods. This information may be transmitted by the agent to the utility server 104 and stored in the SCSI Reservation Database 105. In one embodiment, a system administrator may be able to review the SCSI Reservation Database 105 to determine if there are any incorrect reserves in system 100. In one embodiment, the utility server 104 may also include diagnostic programs, alerts, or other means of monitoring the SCSI Reservation Database 105 to determine if incorrect reserves have been made.

A brief example may illustrate the operation of the system 100. At the start of this example, the utility server 104 acquires the present state information of reserves on the system 100 by polling the agents 112, 122, and 132, that as described above, collect the present reserves from SCSI drivers 111, 121, and 131 and transmit this information to the utility server 104, which stores this information in the SCSI Reservation database 105. As described above, this information may be in the form of tuple (command, key, time). As also discussed above, each SCSI driver 111, 121 and 131 has reserve logging enabled. As any of these drivers perform a reserve related operation, the associated agent is able to monitor and collect the assorted tuple and transmits it to utility server 104, which stores this information in the SCSI Reservation Database 105.

After start up, in this example, application server 101 requires exclusive access to logical unit (LUN) 151 in storage device 150 and sends persistent group reserve SCSI command RI to storage device 150 over the SAN fabric through the SAN switch 140. Storage device 150 completes and acknowledges the reserve request (A1). The SCSI device driver 111 on application server 101, enabled for changes in reserve state-logs this change which agent 112 is monitoring. Agent 112, then communicates this notification (N1) to utility server 104 which then receives the update and stores it in the SCSI Reservation database 105. The SCSI Reservation Database 105 now has an entry updated to indicate that LUN 151 in storage device 150 is reserved by application server 101.

Further activity occurs after the activity described above. For example, application server 101 could be controlled by cluster application software (not shown) to gracefully migrate a reserve of storage logical unit 151 from storage device 150 to application server 103. As part of this procedure, SCSI device driver 111 on application server 101 sends a reserve release (RR2) command for LUN 151 to storage device 150 over the SAN fabric which completes the request and sends acknowledgement (A2). The SCSI device driver 111 on application server 101 logs this change, which agent 112 is monitoring, and in turn passes this release of reserve to utility server 104 (N2), which updates this information in the SCSI Reservation Database 105. In sequence, the SCSI device driver 131 on application server 103 requires exclusive access to LUN 151 in storage device 150 and sends persistent group reserve SCSI command R3 to storage device 150 over the SAN fabric. Storage device 150 completes and acknowledges the reserve request (A3). The SCSI device driver 131 on 103 logs this change which agent 132 is monitoring and in turn this information is transmitted to the utility server 104 and stored in the SCSI Reservation database 105. At this time, the SCSI Reservation database 105 indicates that LUN 151 in storage device 150 is now reserved by application server 103.

Suppose, for example, that instead of a smooth transition as previously described, either operator error or defective software logic causes a different operation. For example, the SCSI device driver 131 on application server 103 sends a break reserve (BR3) command to storage device 150 for LUN 151. The break reserve command completes and storage device 150 acknowledges the reserve request (A3). The SCSI device driver 131 on application server 103, logs this change in reservation which the agent 132 is monitoring and in turn communicates this to utility sever 104 (N3). The utility server 104 stores this information in the SCSI Reservation database 105. However, no reserve change information is received from application node 101 because the change resulted from an error. As a result; utility server 104 generates an administrative alert (since its database indicates a reserve potentially held by two servers) that an invalid state change has occurred. Note that the previous may be also indicative of a successful cluster takeover but is also important as a notification of non-standard behavior on the SAN fabric. Of course, other types of errors or alerts may be generated based on the circumstances. Regardless, all such determinations may require a SCSI Reservation database 105 that heretofore was non-existent.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. In a network storage system comprising at least one application server including a device driver and an agent, at least one switch attached to the at least one application server, at least one storage device attached to the at least one switch and responsive to the device driver of the at least one application server, and a utility server, a network storage monitoring method comprising:
storing data in the device driver related to a storage event created by the device driver in a new data object comprising records of at least a type of event, an identifier of a storage device to which the event relates, and a time at which the event occurred;
sending data via the agent related to the storage event from the at least one application server to the utility server;
receiving the data related to the storage event at the utility server; and
storing the data related to the storage event on the utility server in a database.

2. The method of claim 1, wherein the type of event includes at least a storage reservation request, a storage reservation release, and a reservation break.

3. The method of claim 1, wherein the device driver of at least one application server is a small computer systems interface (SCSI) device driver and at least one storage device employs SCSI.

4. The method of claim 1, wherein sending data is periodically by the agent of the application server.

5. The method of claim 1, further comprising polling the at least one application server to determine a state of each storage device and recording data received from the poll in the data object.

6. The method of claim 5, wherein polling is done by the utility server and includes requesting from each agent device driver data related to a most recent storage event.

7. A computer program product comprising a computer readable storage medium containing instructions that, when read by a computer processor, execute a method comprising:
storing data in a device driver related to a storage event created by the device driver in a new data object comprising records of at least a type of event, an identifier of a storage device to which the event relates, and a time at which the event occurred;
sending data via an agent installed on the device driver related to a storage event from at least one application server to a utility server;
receiving the data related to the storage event at the utility server; and
storing the data related to the storage event on the utility server in a database.

8. The computer program product of claim 7, wherein the method further comprises responding to a poll from the utility sever.

9. The computer program product of claim 7, wherein the computer readable storage medium is part of a storage device control unit.

10. The computer program product of claim 7, wherein the instructions are part of a device driver.

11. The computer program product of claim 10, wherein the device driver is a SCSI device driver.

12. A network storage monitor system comprising:
a device driver running on each of at least one first computer and a monitor application running on a second computer in communication with the each first computer, each first computer also being in communication with a network storage switch, and the network storage switch being in communication with at least one storage device, each device driver sending to the second computer data regarding a storage event when the storage event is initiated by the respective first computer.

13. The system of claim 12, wherein the device driver is a SCSI driver.

14. The system of claim 12, wherein each device driver is coupled to a SCSI agent that stores records of each storage event.

15. The system of claim 14, wherein each storage event includes a type of event, an identifier of a storage device to which the event relates, and a time at which the event occurred.

16. The system of claim 15, wherein the types of event include one of a storage reservation request, a storage reservation release, and a reservation break.
